(19) United States
(12) Patent Application Publication
(10) Pub. No.: US 2025/0348752 A1
(43) Pub. Date: Nov. 13, 2025

(54) METHODS AND SYSTEMS FOR MARKOV KNOWLEDGE DISTILLATION

(71) Applicant: MULTICOM TECHNOLOGIES INC., Petersburg (CA)

(72) Inventors: En-hui YANG, Petersburg (CA); Linfeng YE, Waterloo (CA)

(21) Appl. No.: 19/093,373

(22) Filed: Mar. 28, 2025

Related U.S. Application Data
(60) Provisional application No. 63/571,112, filed on Mar. 28, 2024.

(51) Int. Cl. G06N 3/096

(52) U.S. Cl. CPC G06N 3/096

(57) ABSTRACT

A system, method and computer program product for training a deep neural network model using a pre-trained teacher model. Student training data samples are input to the deep neural network model and teacher training data samples are input to the pre-trained teacher model. The trained deep neural network model is generated using the training data samples to optimize an error function that is evaluated using a plurality of student label prediction outputs and a plurality of Markov transformed teacher label prediction outputs. Each Markov transformed teacher label prediction output is generated based on a teacher label prediction output by the pre-trained teacher model in response to receiving one of the teacher training data samples as an input. Each Markov transformed teacher label prediction output is generated through a Markov transform involving matrix multiplication using a Markov matrix.

### CROSS-REFERENCE TO RELATED APPLICATIONS

This application claims the benefit of U.S. Provisional Application No. 63/571,112 filed on Mar. 28, 2024, which is incorporated by reference herein in its entirety.

### FIELD

This document relates to deep learning models. In particular, this document relates to systems and methods for training deep learning models using knowledge distillation.

### BACKGROUND

Deep neural networks (DNNs) have been applied in a wide range of applications, revolutionizing fields like computer vision, natural language processing, and speech recognition (see, for example, Y. LeCun, Y. Bengio, and G. Hinton, “Deep learning,” nature, vol. 521, no. 7553, pp. 436-444, 2015; and I. Goodfellow, Y. Bengio, and A. Courville, Deep learning. MIT press, 2016). Knowledge distillation is a technique for training a deep learning model by transferring the learnings of a large pre-trained model (referred to as a “teacher model”) to another, typically smaller model (referred to as a “student model”).

Knowledge distillation (KD) is a process that was initially introduced in order to provide model compression (see, for example, Bucilu ̌a, C., Caruana, R., Niculescu-Mizil, A.: Model compression. In: Proceedings of the 12th ACM SIGKDD international conference on Knowledge discovery and data mining. pp. 535-541 (2006)). This knowledge distillation process involved training a smaller student model to match the logits of the larger teacher model. A more generalized knowledge distillation process was subsequently developed, in which temperature scaling is used to soften the logits of both the teacher and student, enabling the student model to mimic the soft probabilities of the teacher model (see, for example, Geoffrey Hinton, Oriol Vinyals, J. D.: Distilling the knowledge in a neural network (2015) hereinafter [6]). Several KD variants have been proposed, including logit-based KD variants (see, for example, Huang, T., You, S., Wang, F., Qian, C., Xu, C.: Knowledge distillation from a stronger teacher. arXiv preprint arXiv:2205.10536 (2022); Jandial, S., Khasbage, Y., Pal, A., Balasubramanian, V. N., Krishnamurthy, B.: Distilling the undistillable: Learning from a nasty teacher. In: Avidan, S., Brostow, G., Cisse, M., Farinella, G. M., Hassner, T. (eds.) Computer Vision—ECCV 2022. pp. 587-603. Springer Nature Switzerland, Cham (2022); Keser, R. K., Toreyin, B. U.: Averager student: Distillation from undistillable teacher (2023), https://openreview.net/forum?id=4isz71_aZN; Kundu, S., Sun, Q., Fu, Y., Pedram, M., Beerel, P.: Analyzing the confidentiality of undistillable teachers in knowledge distillation. In: Ranzato, M., Beygelzimer, A., Dauphin, Y., Liang, P., Vaughan, J. W. (eds.) Advances in Neural Information Processing Systems. vol. 34, pp. 9181-9192. Curran Associates, Inc. (2021), https://proceedings.neurips.cc/paper_files/paper/2021/file/4ca82782c5372a547c104929 f03fe7a9-Paper.pdf; Yang, Z., Zeng, A., Yuan, C., Li, Y.: From knowledge distillation to self-knowledge distillation: A unified approach with normalized loss and customized soft labels. In: Proceedings of the IEEE/CVF International Conference on Computer Vision. pp. 17185-17194 (2023); and Zhao, B., Cui, Q., Song, R., Qiu, Y., Liang, J.: Decoupled knowledge distillation. In: Proceedings of the IEEE/CVF Conference on computer vision and pattern recognition. pp. 11953-11962 (2022); Zheng, K., Yang, E. H.: Knowledge distillation based on transformed teacher matching. In: The Twelfth International Conference on Learning Representations (2024), https://openreview.net/forum?id=MJ3K7uDGGI) and feature-based KD variants (see, for example, Ahn, S., Hu, S. X., Damianou, A., Lawrence, N. D., Dai, Z.: Variational information distillation for knowledge transfer. In: Proceedings of the IEEE/CVF conference on computer vision and pattern recognition. pp. 9163-9171 (2019); Chen, P., Liu, S., Zhao, H., Jia, J.: Distilling knowledge via knowledge review. In: Proceedings of the IEEE/CVF Conference on Computer Vision and Pattern Recognition. pp. 5008-5017 (2021); Park, W., Kim, D., Lu, Y., Cho, M.: Relational knowledge distillation. In: Proceedings of the IEEE/CVF conference on computer vision and pattern recognition. pp. 3967-3976 (2019); Passalis, N., Tefas, A.: Learning deep representations with probabilistic knowledge transfer. In: Proceedings of the European Conference on Computer Vision (ECCV). pp. 268-284 (2018); Peng, B., Jin, X., Liu, J., Li, D., Wu, Y., Liu, Y., Zhou, S., Zhang, Z.: Correlation congruence for knowledge distillation. In: Proceedings of the IEEE/CVF International Conference on Computer Vision. pp. 5007-5016 (2019); Tian, Y., Krishnan, D., Isola, P.: Contrastive representation distillation. In: International Conference on Learning Representations (2019); and Zagoruyko, S., Komodakis, N.: Paying more attention to attention: Improving the performance of convolutional neural networks via attention transfer. In: International Conference on Learning Representations (2016)). These methods have been used in both industry and academia in recent years to train students, yielding distilled students outperforming the students trained alone with label smoothing in terms of accuracy (see, for example, Anil, R., Pereyra, G., Passos, A., Ormandi, R., Dahl, G. E., Hinton, G. E.: Large scale distributed neural network training through online distillation. arXiv preprint arXiv:1804.03235 (2018); Park, W., Kim, D., Lu, Y., Cho, M.: Relational knowledge distillation. In: Proceedings of the IEEE Conference on Computer Vision and Pattern Recognition. pp. 3967-3976 (2019); and Radosavovic, I., Doller, P., Girshick, R., Gkioxari, G., He, K.: Data distillation: Towards omni-supervised learning. In: Proceedings of the IEEE conference on computer vision and pattern recognition. pp. 4119-4128 (2018)).

### SUMMARY

The following summary is intended to introduce the reader to various aspects of the detailed description, but not to define or delimit any invention.

The present disclosure relates to systems, methods and computer program products for training a deep neural network model using a pre-trained teacher model. The methods described herein transform the label predictions output by the pre-trained teacher model using a Markov transform. The deep neural network model is then trained based on these Markov transformed label predictions. This can enable the deep neural network model to be trained from pre-trained teacher models that are configured to prevent model distillation using logit-based KD methods. This may also allow the deep neural network model to be trained in a cross-domain setting where the teacher was trained using training data from a domain different from the training data being used to train the deep neural network.

The Markov transforms may also be trained/learned concurrently with the weight parameters of the deep neural network model. This can enhance the training accuracy for the deep neural network model and also further support training of the deep neural network model in a cross-domain setting.

In an aspect of this disclosure, there is provided a method of training a deep neural network model using a pre-trained teacher model, wherein the pre-trained teacher model is configured to output a teacher label prediction in response to receiving a teacher input value and the deep neural network is configured to output a student label prediction in response to receiving a student input value, the method comprising: inputting a plurality of student training data samples into the deep neural network model and a plurality of teacher training data samples into the pre-trained teacher model, wherein each training data sample comprises a training input value, each training input value has an associated true label, and each true label corresponds to a particular class from amongst a plurality of potential classes; and generating a trained deep neural network model using the plurality of training data samples to optimize an error function of the deep neural network model, wherein the error function is evaluated using a plurality of student label prediction outputs and a plurality of Markov transformed teacher label prediction outputs, wherein each student label prediction output is generated by the deep neural network model in response to receiving one of the student training data samples as an input, wherein each Markov transformed teacher label prediction output is generated based on a teacher label prediction output by the pre-trained teacher model in response to receiving one of the teacher training data samples as an input, and wherein each Markov transformed teacher label prediction output is generated through a Markov transform involving matrix multiplication using a Markov matrix.

Each Markov transformed teacher label prediction output can be generated based on a power transformation of the corresponding teacher label prediction output.

Each teacher label prediction output can include a teacher label prediction probability distribution.

The method can include generating the plurality of Markov transformed teacher label prediction outputs by: generating a plurality of power transformed probability distributions by applying a power transform to each of the teacher label prediction probability distributions output by the pre-trained teacher model in response to receiving the plurality of teacher training data samples; and generating the plurality of Markov transformed teacher label prediction outputs from the plurality of power transformed probability distributions by applying Markov transforms to each power transformed probability distribution.

The plurality of Markov transformed teacher label prediction outputs can be generated using a plurality of class-specific Markov matrices, where each potential class in the plurality of potential classes has a corresponding class-specific Markov matrix.

Each Markov matrix can be defined as a parameter constrained Markov matrix that includes a maximum number of Markov transform parameters that is not greater than a predefined parameter threshold.

The plurality of student training data samples and the plurality of teacher training data samples can be non-overlapping sets.

The teacher model can be pre-trained using a plurality of teacher pre-training data samples; and the plurality of student training data samples and the plurality of teacher pre-training data samples can be non-overlapping sets.

The deep neural network can have a plurality of layers, the plurality of layers including a plurality of intermediate layers arranged between an input layer and an output layer, the deep neural network can have a plurality of weight parameters defining layer connections between each pair of adjacent layers in the plurality of layers, and optimizing the error function can include updating the plurality of weight parameters in response to inputting the plurality of training data samples into the input layer of the deep neural network.

The method can include concurrently training Markov transform parameters of the Markov matrices to optimize the error function of the deep neural network model

In an aspect of this disclosure, there is provided a computer program product for training a deep neural network model using a pre-trained teacher model, wherein the pre-trained teacher model is configured to output a teacher label prediction in response to receiving a teacher input value and the deep neural network is configured to output a student label prediction in response to receiving a student input value, the computer program product comprising a non-transitory computer readable medium having computer executable instructions stored thereon, the instructions for configuring one or more processors to perform a method of training the deep neural network, wherein the method comprises: inputting a plurality of student training data samples into the deep neural network model and a plurality of teacher training data samples into the pre-trained teacher model, wherein each training data sample comprises a training input value, each training input value has an associated true label, and each true label corresponds to a particular class from amongst a plurality of potential classes; and generating a trained deep neural network model using the plurality of training data samples to optimize an error function of the deep neural network model, wherein the error function is evaluated using a plurality of student label prediction outputs and a plurality of Markov transformed teacher label prediction outputs, wherein each student label prediction output is generated by the deep neural network model in response to receiving one of the student training data samples as an input, wherein each Markov transformed teacher label prediction output is generated based on a teacher label prediction output by the pre-trained teacher model in response to receiving one of the teacher training data samples as an input, and wherein each Markov transformed teacher label prediction output is generated through a Markov transform involving matrix multiplication using a Markov matrix.

Each Markov transformed teacher label prediction output can be generated based on a power transformation of the corresponding teacher label prediction output.

Each teacher label prediction output can include a teacher label prediction probability distribution.

The method further can include generating the plurality of Markov transformed teacher label prediction outputs by: generating a plurality of power transformed probability distributions by applying a power transform to each of the teacher label prediction probability distributions output by the pre-trained teacher model in response to receiving the plurality of teacher training data samples; and generating the plurality of Markov transformed teacher label prediction outputs from the plurality of power transformed probability distributions by applying Markov transforms to each power transformed probability distribution.

The plurality of Markov transformed teacher label prediction outputs can be generated using a plurality of class-specific Markov matrices, where each potential class in the plurality of potential classes has a corresponding class-specific Markov matrix.

Each Markov matrix can be defined as a parameter constrained Markov matrix that includes a maximum number of Markov transform parameters that is not greater than a predefined parameter threshold.

The plurality of student training data samples and the plurality of teacher training data samples can be non-overlapping sets.

The teacher model can be pre-trained using a plurality of teacher pre-training data samples; and the plurality of student training data samples and the plurality of teacher pre-training data samples can be non-overlapping sets.

The deep neural network can have a plurality of layers, the plurality of layers including a plurality of intermediate layers arranged between an input layer and an output layer, the deep neural network can have a plurality of weight parameters defining layer connections between each pair of adjacent layers in the plurality of layers, and optimizing the error function can include updating the plurality of weight parameters in response to inputting the plurality of training data samples into the input layer of the deep neural network.

The method can include concurrently training Markov transform parameters of the Markov matrices to optimize the error function of the deep neural network model

In an aspect of this disclosure, there is provided a system for training a deep neural network model using a pre-trained teacher model, wherein the pre-trained teacher model is configured to output a teacher label prediction in response to receiving a teacher input value and the deep neural network is configured to output a student label prediction in response to receiving a student input value, the system comprising: one or more processors; and one or more non-transitory storage mediums; wherein the one or more processors are configured to: input a plurality of student training data samples into the deep neural network model, wherein each training data sample comprises a training input value, each training input value has an associated true label, and each true label corresponds to a particular class from amongst a plurality of potential classes; and generate a trained deep neural network model using the plurality of training data samples to optimize an error function of the deep neural network model, wherein the error function is evaluated using a plurality of student label prediction outputs and a plurality of Markov transformed teacher label prediction outputs, wherein each student label prediction output is generated by the deep neural network model in response to receiving one of the student training data samples as an input, wherein each Markov transformed teacher label prediction output is generated based on a teacher label prediction output by the pre-trained teacher model in response to receiving a teacher training data sample from amongst a plurality of teacher training data samples as an input, and wherein each Markov transformed teacher label prediction output is generated through a Markov transform involving matrix multiplication using a Markov matrix.

The one or more processors can be further configured to perform a method for training a deep neural network model using a pre-trained teacher model as described herein.

It will be appreciated by a person skilled in the art that an apparatus, computer program product, system, or method disclosed herein may embody any one or more of the features contained herein and that the features may be used in any particular combination or sub-combination.

These and other aspects and features of various examples will be described in greater detail below.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a block diagram illustrating an example of a system for training a deep neural network;

FIG. 2A shows an example plot of clusters of predicted labels output by a first pre-trained teacher model;

FIG. 2B shows an example plot of clusters of predicted labels output by a second pre-trained teacher model;

FIG. 2C shows an example plot of clusters of Markov transformed predicted label outputs for the second pre-trained teacher model;

FIG. 3A is a flowchart illustrating an example method of training a deep neural network;

FIG. 3B is a flowchart illustrating an example method of generating a trained deep neural network;

FIG. 4 is a flowchart illustrating an example method of evaluating a student model error function;

FIG. 5 shows an example plot of the conditional mutual information vs. the power parameter γ for a Resnet18 model trained using a self-undermining KD process using the Cifar-10 dataset;

FIG. 6A shows an example plot of the accuracy of a trained deep neural network model vs. the percentage of the training data samples used for training a first deep neural network model type using various training processes based on a first pre-trained model;

FIG. 6B shows an example plot of the accuracy of a trained deep neural network model vs. the percentage of the training data samples used for training a second deep neural network model type using various training processes based on a first pre-trained model;

FIG. 6C shows an example plot of the accuracy of a trained deep neural network model vs. the percentage of the training data samples used for training a third deep neural network model type using various training processes based on a first pre-trained model;

FIG. 6D shows an example plot of the accuracy of a trained deep neural network model vs. the percentage of the training data samples used for training the first deep neural network model type using various training processes based on a second pre-trained model;

FIG. 6E shows an example plot of the accuracy of a trained deep neural network model vs. the percentage of the training data samples used for training the second deep neural network model type using various training processes based on a second pre-trained model; and

FIG. 6F shows an example plot of the accuracy of a trained deep neural network model vs. the percentage of the training data samples used for training the third deep neural network model type using various training processes based on a second pre-trained model.

### DETAILED DESCRIPTION

Various apparatuses or processes or compositions will be described below to provide an example of an embodiment of the claimed subject matter. No embodiment described below limits any claim and any claim may cover processes or apparatuses or compositions that differ from those described below. The claims are not limited to apparatuses or processes or compositions having all of the features of any one apparatus or process or composition described below or to features common to multiple or all of the apparatuses or processes or compositions described below. It is possible that an apparatus or process or composition described below is not an embodiment of any exclusive right granted by issuance of this patent application. Any subject matter described below and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth in order to provide a thorough understanding of the subject matter described herein. However, it will be understood by those of ordinary skill in the art that the subject matter described herein may be practiced without these specific details. In other instances, well-known methods, procedures and components have not been described in detail so as not to obscure the subject matter described herein. The description is not to be considered as limiting the scope of the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices can be directly connected to one another or connected to one another through one or more intermediate elements or devices via an electrical element, electrical signal, or a mechanical element depending on the particular context. Furthermore, the term “communicative coupling” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

Described herein are systems, methods and computer program products for training deep learning models. The systems, methods and computer program products described herein can improve the training flexibility and accuracy of deep learning models trained based on pre-trained teacher models.

The systems, methods, and devices described herein may be implemented as a combination of hardware or software. In some cases, the systems, methods, and devices described herein may be implemented, at least in part, by using one or more computer programs, executing on one or more programmable devices including at least one processing element, and a data storage element (including volatile and non-volatile memory and/or storage elements). These devices may also have at least one input device (e.g. a pushbutton keyboard, mouse, a touchscreen, and the like), and at least one output device (e.g. a display screen, a printer, a wireless radio, and the like) depending on the nature of the device.

Some elements that are used to implement at least part of the systems, methods, and devices described herein may be implemented via software that is written in a high-level procedural language such as object oriented programming. Accordingly, the program code may be written in any suitable programming language such as Python or C for example. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g. downloads), media, digital and analog signals, and the like. The computer useable instructions may also be in various formats, including compiled and non-compiled code.

The present disclosure relates to systems, methods, and computer program products for training deep learning neural network models using pre-trained teacher models. The systems, methods and computer program products described herein can be applied to train student models from a pre-trained teacher model even where the pre-trained teacher model has been configured to hinder or prevent knowledge distillation training processes.

Existing knowledge distillation processes are based on a paradigm in which the teacher model is in a fully cooperative mode and configured to allow its knowledge in whatever form to be transferred to the student. There are many cases, however, where the teacher model may be configured to prevent cooperation with existing knowledge distillation processes.

Training an accurate and effective machine learning model requires time, effort, money, and resources including data and computing infrastructure. Accordingly, it may be desirable to protect or secure the intellectual property (IP) of a trained model so that it is hard for a student model to learn from and mimic the behavior of the trained model.

Once a trained model is made available to provide a “black-box” input-output service, the input-output function of the model is always available for the student to leverage regardless of whether or not the trained model is configured to cooperate with knowledge distillation processes. As a result, logit-based KD methods may pose a threat to the teacher model since these methods can help a student model obtain a competitive advantage by either leaking proprietary information of the teacher model (such as valuable training data and/or model parameters) or leveraging the teacher's input-output knowledge to improve the student performance.

To mitigate the threats posed by logit-based KD methods, the concept of a nasty teacher was introduced (see, for example, Ma, H., Chen, T., Hu, T. K., You, C., Xie, X., Wang, Z.: Undistillable: Making a nasty teacher that {cannot}teach students. In: International Conference on Learning Representations (2021)). A nasty teacher model is a teacher model that is trained to degrade the accuracy of a student model if the student model is trained using the distillation process of applying logit-based KD methods to the teacher model. A method called self-undermining knowledge distillation was developed to train and build nasty teacher models. It has been demonstrated that the distillation process of using a standard KD method (see for example, Geoffrey Hinton, Oriol Vinyals, J. D.: Distilling the knowledge in a neural network (2015)) to train a student model based on a pre-trained nasty teacher model results in significant loss in the accuracy of the student model.

To a large extent, the concept of a nasty teacher model is not well-defined for at least two reasons. First, logit-based KD methods are not fixed. Many different logit-based KD methods exist and there are various possible ways to develop logit-based KD methods. As a result, implementing a distillation process by applying a first type of logit-based KD method to a particular nasty teacher may degrade the accuracy of the student while implementing the distillation process by applying a different logit-based method to the same nasty teacher can improve the accuracy of the student.

Second, a student model trained alone using a cross entropy loss plus label smoothing penalty (LS student) generally outperforms the same student model trained alone with using cross entropy loss (CE student) in accuracy. Thus, evaluating whether there is a benefit from applying a logit-based KD method to a teacher model should not be determined by its comparison with the CE student, but rather with the LS student. If a distillation process yields a distilled student outperforming the LS student, then there is a benefit. Otherwise, there is no incentive to leverage the teacher model through that particular logit-based KD method. Indeed, it has been shown that by dropping the temperature from the student side, the distilled student model from the standard KD method will never perform worse than the LS student if the temperature on the teacher model side is approaching infinity (regardless of the nature of the teacher model).

In this context, two knowledge distillation (KD) related concepts are described below, namely a distillable DNN and a KD-resistant DNN.

A DNN is said to be a distillable DNN if, when that DNN is used as a black-box input-output teacher model, it can be distilled by a KD method to train a student model so that the distilled student model outperforms the student model trained alone with label smoothing (LS student) in terms of accuracy. In other words, a DNN is said to be distillable with respect to a student model if there is a logit-based KD method which, when applied to train the student model based on the teacher model, yields a distilled student model outperforming the LS student model in accuracy.

A DNN is said to be KD-resistant with respect to a specific KD method if, when that DNN is used as a black-box input-output teacher, it cannot be distilled by that specific KD method to yield a distilled student outperforming LS student in terms of accuracy. In other words, a DNN is said to be KD-resistant with respect to a specific KD method (and student model) if the DNN cannot be distilled by that specific KD method into a distilled student model outperforming the LS student in accuracy.

As explained in further detail herein below, the inventors have demonstrated that nasty teachers trained by self-undermining KD are KD-resistant with respect to existing state-of-the-art logit-based KD methods. The present disclosure provides a novel knowledge distillation process referred to herein as Markov Knowledge Distillation (referred to as Markov KD or MKD). The inventors have found that the Markov Knowledge Distillation process is simple, powerful, and distribution-based, and can be applied in conjunction with any other distribution-based KD method.

The methods described herein can be applied to train student models based on nasty teacher models pre-trained by self-undermining KD. In particular, nasty teacher models trained by self-undermining KD can be rendered fully distillable using the MKD methods described herein even while those nasty teacher models remain KD-resistant when existing KD methods are used.

The methods described herein can also be used to train student models based on normal teacher models resulting in improved performance of those student models as compared to student models trained on the same teacher models using existing KD methods.

The methods described herein may also enable student models to be trained using cross-domain training sets. That is, teacher models trained using training data from a first domain can be used to train student models using student training data from a second domain using the methods described herein.

As described in further detail herein below, this distribution-based KD method can use the prediction output distributions from a teacher model (e.g. the softmax of logits) to train a student model. The methods described herein also require less knowledge from the teacher model in comparison with a logit-base KD method in order to train an accurate student model.

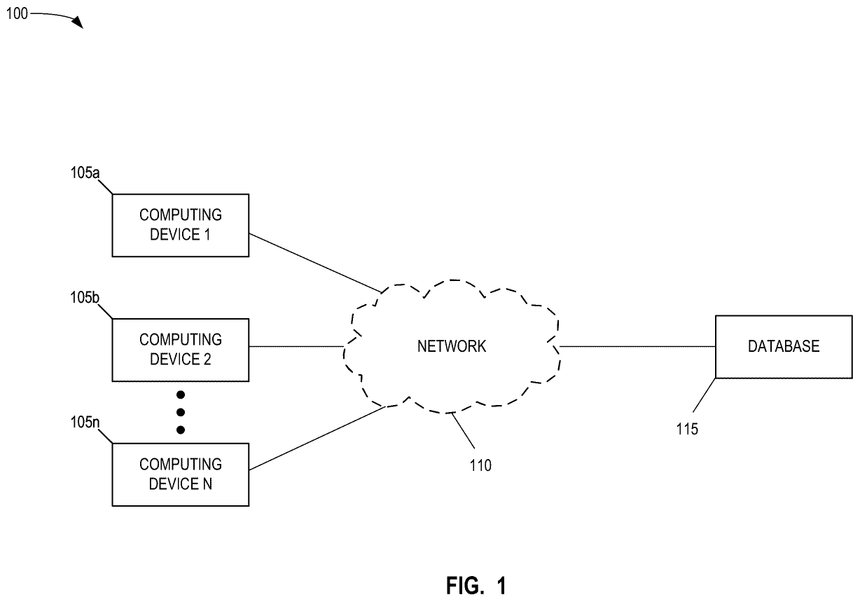

Referring now to FIG. 1, shown therein is a block diagram illustrating an example model training system 100. In the example illustrated, system 100 includes a plurality of training computing devices 105a-105n. One or more computing devices 105 can be configured to perform a method of training a deep learning model, such as the example methods 300 and 320 described in further detail herein below.

Each computing devices 105 can be implemented using one or more processors such as general-purpose microprocessors. The processor(s) control the operation of the computing device 105 and in general can be any suitable processor such as a CPU, GPU, microprocessor, controller, digital signal processor, field programmable gate array, application specific integrated circuit, microcontroller, or other suitable computer processor that can provide sufficient processing power processor depending on the desired configuration, purposes and requirements of the system 100.

Computing device 105 can include the processor(s), a power supply, memory, and a communication module operatively coupled to the processor.

The memory unit can include both transient and persistent data storage elements, such as RAM, ROM, one or more hard drives, one or more flash drives or some other suitable data storage elements such as disk drives, etc.

As shown in FIG. 1, the computing devices 105 can be connected to one another through a network 110. The network 110 can communicatively couple the computing devices 105 to one another, e.g. using a wired or wireless communication protocol (e.g., Bluetooth, Bluetooth Low-Energy, WiFi, ANT+ IEEE 802.11, etc.). The computing devices 105 can also be communicatively coupled over, for example, a wide area network such as the Internet.

Alternatively or in addition, the computing devices 105 can be coupled directly to one another, e.g. using a wired connection such as Universal Serial Bus (USB) or other port.

The computing devices 105 can be configured to communicate with one another to transmit data relating to training and/or storing a deep learning model. For example, the computing devices 105 may be configured to train a deep learning model individually or in parallel. Accordingly, the computing devices 105 can be configured to transmit various types of data (e.g. weight data, activation data, gradient data, predicted label distribution data, Markov transform parameter data) therebetween during the process of training and/or storing a deep learning model.

The trained neural network model may be stored in non-transitory memory accessible to one or more of the computing devices 105. The particular parameters (e.g. hyper-parameter values) and training (e.g. mini-batches, training epochs etc.) of the deep neural network model can vary depending on the architecture of the model and/or the particular application for which the deep learning model is being trained.

Optionally, system 100 can include a database 115. The database 115 can include suitable data storage elements for persistent data storage. The database 115 can store various different types of data that may be usable by the computing devices 105, such as a pre-trained teacher model, parameters of a deep neural network model, trained model weights, training datasets, predicted label distributions, and so forth. The database 115 may also be used to store, at least temporarily, Markov transform parameters of the Markov matrices used to train student models in accordance with the methods described herein.

Although database 115 is shown separately from the computing devices 105, it should be understood that database 115 may be co-located with, and/or integrated with, one or more of the computing devices 105.

The computing device(s) 105 may communicate with the pre-trained teacher model to input teacher training samples into the teacher model and receive teacher label prediction outputs from the teacher model in response to the training input samples.

Optionally, a pre-trained teacher model may be stored in database 115. This may provide easy access to the teacher model for training a student model. Alternatively, the pre-trained teacher model may be accessible to the computing device(s) 105, for instance over a network or the Internet.

The following notation will be used to facilitate the discussion herein. For a positive integer C, let [C] [symbol] {1, . . . , C}. For a classification problem with C class labels, the set of potential class labels (i.e. the plurality of potential classes) can be represented by [C]. The set of potential class labels thus includes C class labels (i.e. C is the number of potential class labels in the set of class labels [C]).

P([C]) can denote the set of all predicted label probability distributions over the set of potential class labels [C]. For any two probability distributions in the set of predicted label probability distributions (i.e. for any two p₁, p₂ϵP([C])), the cross entropy (CE) H(p₁, p₂) of those probability distributions p₁ and p₂ can be defined as

$$H ( {p}_{1} , {p}_{2} ) = {\sum }_{i = 1}^{C} - {p}_{1} ( i ) ln {p}_{2} ( i ) , \qquad ( 1 )$$

where ln denotes the logarithm with base e.

The Kullback-Leibler (KL) divergence (or relative entropy) D(p₁∥p₂) between the pair of probability distributions p₁ and p₂ can be defined as

$$D ( {p}_{1} \vert \vert {p}_{2} ) = {\sum }_{i = 1}^{C} {p}_{1} ( i ) ln [ \frac{{p}_{1} ( i )}{{p}_{2} ( i )} ] . \qquad ( 2 )$$

For any specific class y in the set of potential classes [C](i.e. for any yϵ[C]) and any predicted label distribution p in the set of predicted label distributions P([C]) (i.e. any pϵP([C])), the CE H of the one-hot probability distribution corresponding to that class y and that probability distribution p can be defined as

$$H ( y , p ) = - ln p ( y ) \qquad ( 3 )$$

A classification deep neural network (DNN) model can be considered as a mapping from raw data xϵ [symbol] to a probability distribution qₓ over the plurality of potential labels (i.e. qₓϵP([C])). The mapping can output/predict an output label ŷ corresponding to a particular potential class with a label prediction probability qₓ(ŷ). That is, the deep neural network model outputs a label prediction probability qₓ(ŷ) that the predicted label ŷ is the correct label in response to receiving an input value x. The deep neural network model may output a label prediction probability distribution qₓ that includes a label prediction probability for each potential output label in the plurality of potential labels.

For a DNN with a mapping xϵ [symbol] →qₓ, θ can denote the weight vector of the DNN consisting of all its connection weights (i.e. θ can represent the plurality of weight parameters defining layer connections between adjacent layers of the DNN). Whenever there is no ambiguity, the distribution qₓ can also be represented by q_{x,θ}.

For random variables X and Y, P_{X} can represent the probability distribution of X, P_{X|Y} can represent the conditional probability distribution of X given Y, and [symbol] [⋅] can represent the expectation computed with respect to X. [symbol] can denote an m×n real matrix, and [symbol] can denote the n×n identity matrix. The i^{th} row of the matrix [symbol] can be denoted by [symbol] [i].

### Power Transform of Probability Distribution

A power transform can be applied to a probability distribution p. Given a predicted label probability distribution p in the set of predicted label distributions P([C]) (i.e. pϵP([C])) and a scaling value γ that is the inverse of the scaling temperature (i.e. γ=1/T>0) the power transform of the predicted label distribution p can be a power transformed probability distribution \hat{p}ϵP([C]) determined according to

$$\hat{p} ( i ) = \frac{{p ( i )}^{γ}}{{\sum }_{j ∈ C} {p ( j )}^{γ}} , ∀ i ∈ [ C ]$$

If the predicted label distribution p is the softmax of a logit vector (l₁, l₂, . . . , l_{C}), the power transformed probability distribution p corresponds to the softmax of the temperature scaled logit vector (l₁/T, l₂/T, . . . , l_{C}/T). Accordingly, temperature scaling can be applied directly to the probability distribution itself.

### Knowledge Distillation

Let (X, Y) be a pair of random variables, the distribution of which governs a training set, where Xϵ [symbol] represents the raw input data and Y is the ground truth label of X. A pre-trained teacher model can be represented as a fixed teacher mapping: xϵ [symbol] →pₓ. T>0 can be defined as a scaling temperature. As explained above, temperature scaling and the power transform can be used in effectively equivalent manners. Accordingly, the standard knowledge distillation process used to train a student DNN: xϵ [symbol] qₓ can be modified to use the power transformed knowledge distillation minimization problem

$${min}_{θ} {𝔼}_{( X , Y )} [ H ( Y , {q}_{X , θ} ) + β {T}^{2} D ( {\hat{p}}_{X} \vert \vert {\hat{q}}_{X , θ} ) ] \qquad ( 4 )$$

where β>0 is a hyperparameter, \hat{p}ₓ is a teacher power transformed probability distribution corresponding to the teacher model probability distribution output pₓ in response to the input x, and \hat{q}_{x,θ} is a student power transformed probability distribution corresponding to the student model probability distribution output q_{x,θ} in response to the input x. This allows the standard KD process to be modified to use a distribution-based distillation method.

### Self-Undermining KD

A method called self-undermining KD can be used to train and build nasty teacher models. A pre-trained normal teacher can be represented by the normal teacher mapping: xϵ [symbol] →pₓ. T>0 can be defined as the scaling temperature. In self-undermining KD, a nasty student model with a nasty student mapping: xϵ [symbol] →qₓ corresponds to an untrained nasty teacher model. The untrained nasty teacher model typically has the same network architecture as the pre-trained normal teacher. The nasty teacher model can then be trained by optimizing the self-undermining KD minimization problem

$${min}_{θ} {𝔼}_{( X , Y )} [ H ( Y , {q}_{X , θ} ) - ω {T}^{2} D ( {\hat{q}}_{X , θ} \vert \vert {\hat{p}}_{X} ) ] \qquad ( 5 )$$

where ω is a hyperparameter. In comparison with the modified standard knowledge distillation minimization shown in equation (4) above, the training process in self-undermining KD is specifically configured to push the student power transformed probability distribution \hat{q}_{x,θ} away from the teacher power transformed probability distribution \hat{p}ₓ.

### Markov Matrix and Conditional Mutual Information

A real-valued C×C matrix [symbol] is considered a Markov matrix if all of the elements of the matrix are nonnegative, and the sum of each row is equal to 1.

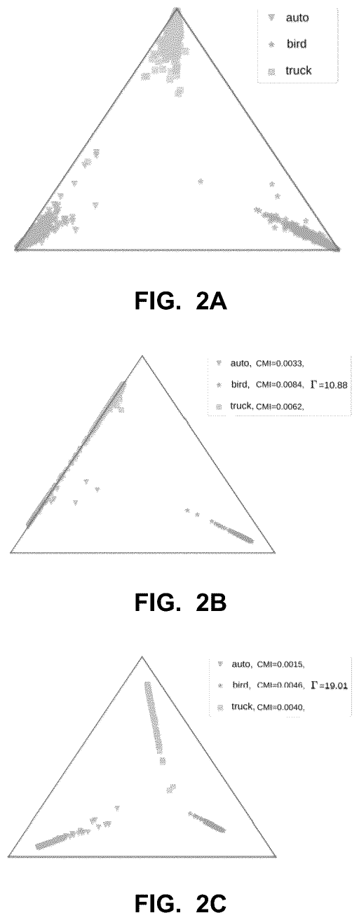

For a DNN that defines a mapping xϵ [symbol] →pₓ, Ŷ can represent the label predicted by the DNN (i.e. the predicted label output by the DNN) with a predicted label probability p_{X}(Ŷ) in response to receiving the input value/sample X. Y→X→Ŷ forms a Markov chain in the indicated order. For each label yϵ[C], consider all input samples x having the ground truth label y. The DNN maps this subset of input samples into a cluster of probability distributions pₓ in the predicted label space P([C]) (see e.g. FIGS. 2A-2C discussed below).

The concentration of a cluster of probability distributions (also referred to as an intra-class concentration) can be represented by the conditional mutual information I(X, Ŷ|Y=y) between the input X and the predicted label Ŷ given the ground truth label Y=y (as described in further detail in U.S. patent application Ser. No. 18/829,437, the entirety of which is incorporated herein by reference). The value I(X; Ŷ|y) quantifies the concentration of the cluster corresponding to a particular class Y=y in the set of potential classes (also referred to as the class-specific intra-class concentration). The class-specific intra-class concentration value represents a relative concentration of the set of predicted labels Ŷ output by a deep neural network in response to the deep neural network receiving as inputs a set of input values X each having the same associated true label Y for a specific class y in the plurality of potential classes [C].

The conditional mutual information I(X, Ŷ|Y=y) can be determined as the conditional average KL divergence between a probability distribution pₓ in the cluster and a centroid o_{y} of the cluster given Y=y (i.e. the average divergence from the centroid for the set of predicted labels)

$$I ( X , \hat{Y} \vert Y = y ) = {\sum }_{x} {P}_{X \vert Y} ( x \vert y ) D ( {p}_{x} \vert \vert {o}_{y} ) \qquad ( 6 )$$

$$where$$

$${o}_{y} = {\sum }_{x} {P}_{X \vert Y} ( x \vert y ) {p}_{x}$$

is the conditional distribution of Ŷ given Y=y, i.e., o_{y} is the centroid of the cluster. The centroid o_{y} of a given cluster is the average of the predicted label output values/distributions qₓ with respect to the conditional distribution P_{X|Y}(⋅|y). The conditional mutual information (CMI) I(X;Ŷ|Y) for the DNN is then the average concentration of all clusters corresponding to all labels.

A separation distance Γ (also referred to as an inter-class separation) can be used to measure how far apart clusters corresponding to all labels are from each other (as described in further detail in U.S. patent application Ser. No. 18/829,437, the entirety of which is incorporated herein by reference). A second pair of random variables (U, V) can be provided that are independent of (X, Y) and have the same joint distribution as that of (X, Y). The separation distance Γ of clusters corresponding to all labels for a DNN can be represented by the inter-class separation function:

$$Γ = {𝔼}_{( X , Y , U , V )} [ {I}_{Y \neq V} H ( {p}_{X} , {p}_{U} ) ] \qquad ( 7 )$$

where I_{Y} [symbol] _{V} is the indicator function of the event {Y [symbol] V}.

As described in further detail herein below, clusters can be made more concentrated and spaced farther apart from each other without modifying or re-training the DNN by multiplying each probability distribution pₓ by a Markov matrix [symbol] , where the probability distribution pₓ is regarded as a row vector.

### KD-Resistance of Nasty Teachers

The KD-resistance of nasty teachers trained by self-undermining KD as against popular existing logit-based KD methods can be readily shown. It has been demonstrated that for various student models, the distillation process of applying the standard KD method to nasty teacher models trained by self-undermining KD results in significant loss in student accuracy (see, for example, Ma, H., Chen, T., Hu, T. K., You, C., Xie, X., Wang, Z.: Undistillable: Making a nasty teacher that {cannot}teach students. In: International Conference on Learning Representations (2021), https://openreview.net/forum?id=Ozvfm-nZqQs). Therefore, these nasty teachers are KD-resistant with respect to standard KD methods.

Modified logit-based KD methods have subsequently been proposed that fully or partially recovered the resulting loss in student accuracy (see, for example, Jandial, S., Khasbage, Y., Pal, A., Balasubramanian, V. N., Krishnamurthy, B.: Distilling the undistillable: Learning from a nasty teacher. In: Avidan, S., Brostow, G., Cisse, M., Farinella, G. M., Hassner, T. (eds.) Computer Vision—ECCV 2022. pp. 587-603. Springer Nature Switzerland, Cham (2022) hereinafter [9]; Keser, R. K., Toreyin, B. U.: Averager student: Distillation from undistillable teacher (2023), https://openreview.net/forum?id=4isz71_aZN hereinafter [12]; and Kundu, S., Sun, Q., Fu, Y., Pedram, M., Beerel, P.: Analyzing the confidentiality of undistillable teachers in knowledge distillation. In: Ranzato, M., Beygelzimer, A., Dauphin, Y., Liang, P., Vaughan, J. W. (eds.) Advances in Neural Information Processing Systems. vol. 34, pp. 9181-9192. Curran Associates, Inc. (2021), https://proceedings.neurips.cc/paper_files/paper/2021/file/4ca82782c5372a547c104929 f03fe7a9-Paper.pdf hereinafter [16]). However, as shown in Table 1 (the last three columns), none of the distilled students from the modified KD methods outperforms the respective LS trained student model. Therefore, nasty teacher models trained by self-undermining KD are still KD-resistant with respect to these KD methods, even though these modified methods were designed specifically to distill nasty teachers.

TABLE 1
Illustration of KD-resistance of nasty teachers
against various state-of-the-art logit-based KD methods
Cifar-10

| Teacher | Student | | KD | DKD | DIST | NKD | MLD | Skep. | HTC | Avg. |
|---|---|---|---|---|---|---|---|---|---|---|
| model | model | LS | [6] | [39] | [8] | [34] | [10] | [16] | [9] | [12] |
| R18 | CNN | 87.40 | 82.11 | 86.89 | 85.28 | 85.64 | 85.59 | 86.71 | 87.33 | 83.02 |
| | RC20 | 92.53 | 88.42 | 92.30 | 84.70 | 91.57 | 91.67 | 91.85 | 92.48 | 88.73 |
| | RC32 | 93.36 | 89.61 | 92.49 | 85.85 | 92.11 | 92.56 | 92.98 | 93.26 | 90.33 |

In addition to logit-based KD methods designed specifically to distill nasty teacher models, various other logit-based KD methods have been developed which deliver good distillation performance from normal teachers (see, for example, Huang, T., You, S., Wang, F., Qian, C., Xu, C.: Knowledge distillation from a stronger teacher. arXiv preprint arXiv:2205.10536 (2022) herein referred to as [8]; Jin, Y., Wang, J., Lin, D.: Multi-level logit distillation. In: Proceedings of the IEEE/CVF Conference on Computer Vision and Pattern Recognition. pp. 24276-24285 (2023) herein referred to as [10]; Yang, Z., Zeng, A., Yuan, C., Li, Y.: From knowledge distillation to self-knowledge distillation: A unified approach with normalized loss and customized soft labels. In: Proceedings of the IEEE/CVF International Conference on Computer Vision. pp. 17185-17194 (2023) herein referred to as [34]; and Zhao, B., Cui, Q., Song, R., Qiu, Y., Liang, J.: Decoupled knowledge distillation. In: Proceedings of the IEEE/CVF Conference on computer vision and pattern recognition. pp. 11953-11962 (2022) herein referred to as [39]). The KD-resistance of nasty teachers against these methods was evaluated as well. Table 1 shows their respective results on Cifar-10 dataset for a nasty teacher model R18 and student models based on CNN, RC20, and RC32. As can be seen from Table 1, none of the resulting distilled student models from these existing KD methods outperforms the respective LS student. Therefore, nasty teacher models trained by self-undermining KD can be seen to be KD-resistant with respect to these state-of-the-art KD methods as well.

### Markov Knowledge Distillation

As noted above, a classification DNN can be represented as a mapping: Xϵ [symbol] →pₓ that maps input samples x with different labels (i.e. input samples corresponding to different classes) into clusters of probability distributions pₓ (also referred to as label prediction output distributions) in the predicted label space P([C]). Each class label is associated with a corresponding cluster. FIGS. 2A-2C illustrate a visualization of probability distributions for three randomly selected labels from the training set of the CIFAR-10 dataset.

In the visualizations shown in FIGS. 2A-2C, only the probabilities of the selected labels are considered for each probability distribution in the three clusters corresponding to the selected labels. The probabilities were normalized to define a 3 dimensional probability vector. The resulting probability vector was then projected into the 2 dimensional simplex. This allows the clusters corresponding to the three labels to be projected into and viewed in the two dimensional simplex.

FIGS. 2A-2B shows a plot of the resulting three projected clusters of probability distributions for a normal teacher model trained with the standard cross-entropy loss (FIG. 2A) and for a nasty teacher model trained by self-undermining KD (FIG. 2B).

As can be seen from FIGS. 2A and 2B, the projected clusters of the nasty teacher model have a notably different pattern from the projected clusters of the normal teacher model. The probability vectors within each cluster of the nasty teacher model have a strong linear relationship, which aligns with previous observations that the nasty teacher model's output probability has multiple peak entries.

As can be seen from FIG. 2B, the projected clusters of input samples predicted to be automobiles and trucks by the nasty teacher model also have a strong linear relationship and are also interconnected and mixed together. This results in a negative impact on the ability of existing state-of-the-art KD methods to distill nasty teacher models.

Improving the concentration of the probability distributions within each cluster may allow for knowledge distillation methods to be applied to train student models even without modifying the nasty teacher model itself. By applying a Markov transform to the probability distributions output by the teacher model the concentration of the probability distributions within each cluster can be improved. For example, a class-specific Markov matrix can be determined for each cluster (i.e. for the probability distributions corresponding to each potential class). That is, for each cluster corresponding to a label c, a C×C Markov matrix [symbol] for that label can be identified. Each probability distribution pₓ in a given cluster corresponding to the label c can then be multiplied by that Markov matrix [symbol] .

FIG. 2C shows the resulting projected clusters after a Markov transform using class-specific Markov matrices [symbol] , ∀cϵ[C] is applied to the projected clusters of probability distributions for the nasty teacher model trained by self-undermining KD. Comparing FIG. 2C with FIG. 2A and FIG. 2B, it is clear that the projected clusters in FIG. 2C are now well separated and look more similar to the clusters generated by the normal teacher (as shown in FIG. 2A), and are each more concentrated than the clusters generated by the nasty teacher (as shown in FIG. 2B).

As previously noted, Y→X→Ŷ forms a Markov chain, where Ŷ is the label predicted by the DNN with probability pₓ(Ŷ) in response to the input X. A Markov transformed predicted label \tilde{Y} can then be defined according to:

$$Pr \{ \tilde{Y} = j \vert Y = c , X = x , \hat{Y} = i \} = ( i , j ) , ∀ c , x , i , j \qquad ( 8 )$$

where [symbol] (i,j) is the element at the i^{th} row and j^{th} column of the Markov matrix [symbol] . The conditional distribution of the Markov transformed predicted label f given the true label Y=c and input value X=x is exactly pₓ [symbol] i.e. the predicted label probability multiplied by the class-specific Markov matrix). In other words, given a true label Y=c and an input value X=x, \tilde{Y} is the predicted label output after the Markov transform [symbol] is applied to the probability distribution pₓ, whereas Ŷ is the predicted label output before Markov transform.

As discussed herein above, the concentration of the cluster of distributions pₓ corresponding to the label c is the CMI I(X; Ŷ|Y=c). After applying the Markov transform, the concentration of the Markov transformed cluster corresponding to the label c is then equal to I(X; Ŷ|Y=c). Likewise, the separation distance Γ among Markov transformed probability distribution clusters corresponding to all labels can be computed similarly by simply replacing Y with Y.

As an example, FIGS. 2B and 2C illustrate the probability distribution clusters before and after a Markov transform is applied. From FIGS. 2B and 2C, we see that after applying the Markov transform, the CMI value of each probability distribution cluster decreases while the separation distance Γ increases. This is consistent with the visual effect of those clusters shown in FIGS. 2B and 2C.

It can also be shown that the CMI value of each probability distribution cluster will not increase after a Markov transform is applied. That is, for any Markov matrices [symbol] , cϵ[C], the CMI can be represented as:

$$I ( X ; \tilde{Y} \vert Y = c ) \leq I ( X , \hat{Y} \vert Y = c ) , ∀ c ∈ [ C ] \qquad ( 9 )$$

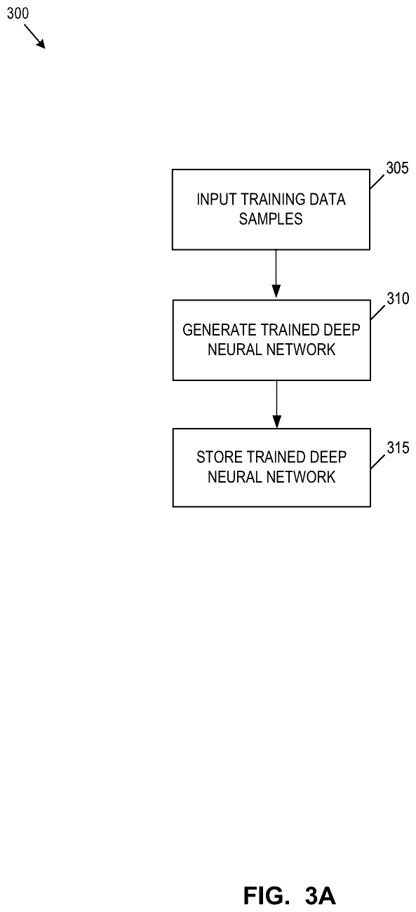

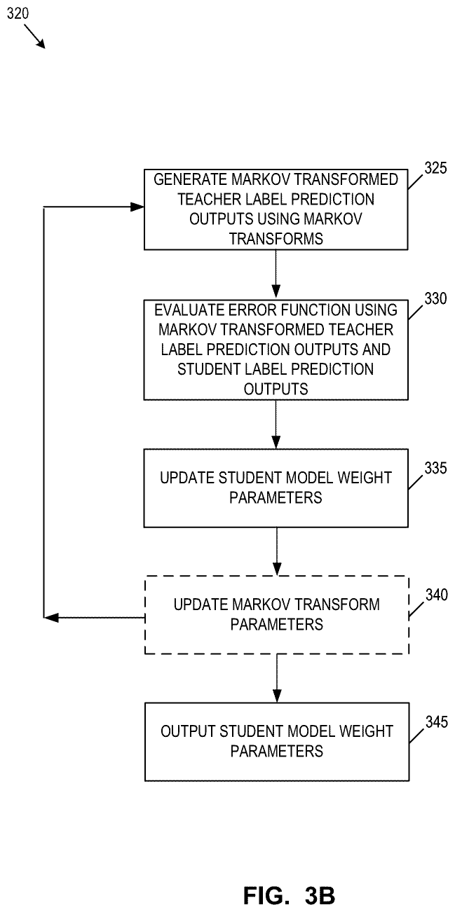

Referring now to FIG. 3A, shown therein is an example method 300 for generating a trained deep neural network using a pre-trained teacher model. The method 300 may be used with a model training system such as system 100 for example. The pre-trained teacher model can be a model configured to output a teacher label prediction in response to receiving a teacher input value. The deep neural network can be a student neural network model configured to output a student label prediction in response to receiving a student input value.

A deep neural network (such as the pre-trained teacher model and the student deep neural network model) generally includes a plurality of layers arranged between an input layer and an output layer. The plurality of layers includes a plurality of intermediate layers arranged between the input layer and the output layer. Inputs are provided to the input layer and the deep neural network is configured to output a predicted label in response to receiving the input value. The deep neural network may output a predicted classification or probability distribution of classifications from the output layer identifying a predicted classification for the input value.

At 305, a plurality of training data samples can be input into the input layer of each deep neural network. The plurality of training data samples can be contained within a training set used to train the deep neural network. The plurality of training data samples can include a plurality of student training data samples and a plurality of teacher training data samples. The student training data samples refers to the input values input to the student model while the teacher training data samples refer to the input values input to the teacher model.

The student training data samples and teacher training data samples used during method 300 (and method 320) are generally the same training data set. Alternatively, the student training data samples and teacher training data samples can be different. For example, the plurality of student training data samples and the plurality of teacher training data samples can be non-overlapping sets.

It need not be the case that the student training data samples are the same as the teacher pre-training data that was used to pre-train the teacher model. Optionally, the student training data samples may include training data from a first training data set (e.g. a first data domain) while the teacher pre-training data that was used to pre-train the teacher model may include training data from a second training data set (e.g. a second data domain), and the first training data set and/or first data domain and the second training data set and/or second data domain may not overlap. That is, the teacher model may be used to provide cross-domain training to the student model.

A plurality of student training data samples can be input into the deep neural network model being trained. A plurality of teacher training data samples can be input into the pre-trained teacher model. Each training data sample can include a training input value. Each training input value has an associated true label. Each true label corresponds to a specific class from amongst a plurality of potential classes.

At 310, the trained deep neural network can be generated using the plurality of training data samples. Generating the trained deep neural network can include optimizing an error function of the deep neural network.

The error function (also referred to as a student error function or student loss function) can be defined in various ways to represent an error value or rate reflecting the accuracy of the classifications output by the DNN (e.g. an error rate or cross entropy upper bound). The error function can be defined based on a difference or divergence between the classifications output by the DNN being trained and the classifications output by the pre-trained teacher model. The particular definition and configuration of the error function can vary, for instance different knowledge distillation error functions may be used.

In general, the error function can be evaluated using a plurality of student label prediction outputs and a plurality of Markov transformed teacher label prediction outputs. Each student label prediction output can be generated by the deep neural network model in response to receiving one of the student training data samples as an input. Each Markov transformed teacher label prediction output can be generated based on a teacher label prediction output by the pre-trained teacher model in response to receiving one of the teacher training data samples as an input. Each Markov transformed teacher label prediction output is generated through a Markov transform involving matrix multiplication using a Markov matrix.

The deep neural network can include a plurality of weight parameters defining layer connections between each pair of adjacent layers in the plurality of layers. The weight parameters can be optimized through an iterative optimization process to improve the performance (e.g. minimize the error function of the deep neural network). Various standard learning algorithms can be used to optimize the weight parameters, for instance using backward propagation and gradient descent algorithms.

Optionally, the Markov transforms may also be trained concurrently with the weight parameters of the DNN. For instance, each Markov matrix can be defined to include a set of trainable Markov transform parameters that can be optimized concurrently or in parallel with the student loss function.

An example of an iterative optimization process 320 that optimizes the error function based on Markov transformed teacher label prediction outputs is described below with reference to FIG. 3B. The optimization process can be used to generate a trained deep neural network model, for instance at step 310 of method 300.

The trainable parameters namely the weight parameters θ (and optionally Markov transform parameters) can be initialized by defining initial values θ° and { [symbol] }_{cϵ[C]} for the set of trainable parameters.

At 325, a plurality of Markov transformed teacher label prediction outputs can be generated. Each Markov transformed teacher label prediction output can be generated based on a teacher label prediction output by the pre-trained teacher model in response to receiving one of the teacher training data samples as an input. Each teacher label prediction output can include a teacher label prediction probability distribution.

As noted above, the teacher training data samples may be the same as, or different from, the student training samples provided as inputs to the deep neural network model. Using the Markov transformed teacher label prediction outputs allows the student neural network model to be trained even in cases where the teacher training data samples are different from the student training samples. The use of Markov transformed teacher label prediction outputs also allows the student model to be trained using training data that is different from the pre-training data used to pre-train the pre-trained teacher model.

A Markov transformed teacher label prediction output can be generated based on a power transformation of the corresponding teacher label prediction output. For an input sample x, a power transform converts the output probability distribution pₓ of the teacher (i.e. the teacher label prediction output) into the power transformed distribution \hat{p}ₓ (i.e. the power transformed teacher label prediction output). As described herein above, the power transform can operate similarly to temperature scaling.

In the methods described herein, the power transform can be used to increase the CMI I(X; Ŷ|Y) of the teacher model. In the context of KD, it has been found to be beneficial to increase I(X; Ŷ|Y), whereas in the context of training a DNN for its own performance, it is beneficial to minimize I(X; Ŷ|Y). Since the teacher is a fixed pre-trained model, the power parameter γ=1/T can be determined in advance of training the student deep neural network model.

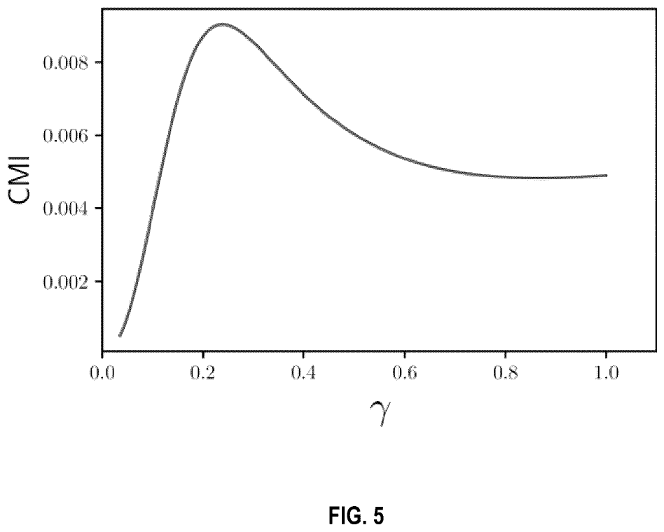

FIG. 5 shows a plot of the CMI vs. the power parameter γ for a Resnet18 model trained by self-undermining KD on the Cifar-10 dataset. As can be seen from FIG. 5, the optimal value for the power parameter γ is γ=0.237. The CMI value peaks when the power parameter γ=0.237; the CMI value using this power parameter is 83.3% larger than the CMI value before the power transformation. As noted above, the optimal power parameter γ value can be pre-defined for the pre-trained teacher model, for instance using a ternary search method.

As noted above, the Markov transformed teacher label prediction outputs can optionally be generated by first generating a plurality of power transformed probability distributions. The power transformed probability distributions can be generated by applying a power transform to each of the teacher label prediction probability distributions output by the pre-trained teacher model in response to receiving the plurality of teacher training data samples. The plurality of Markov transformed teacher label prediction outputs can then be generated from the plurality of power transformed probability distributions by applying Markov transforms to each power transformed probability distribution.

For each input sample x with its ground truth label c, a Markov transform using a Markov matrix [symbol] further converts the power transformed distribution \hat{p}ₓ into the Markov transformed distribution \tilde{p}ₓ:

$${\tilde{p}}_{x} = {\hat{p}}_{x} \qquad ( 10 )$$

The plurality of Markov transformed teacher label prediction outputs can be generated using a plurality of class-specific Markov matrices. Each potential class in the plurality of potential classes can have a corresponding class-specific Markov matrix. That is, each different label can have a corresponding class-specific Markov matrix [symbol] , cϵ[C].

As noted above, the Markov matrices may also be trained during the process of training the deep neural network model. To facilitate the training of the Markov matrices, each Markov matrix [symbol] can be defined using the following form:

$$= softmax ( ) \qquad ( 11 )$$

where [symbol] is any trainable C×C real-valued matrix, and the softmax function is applied to each row of [symbol] so that [symbol] is a Markov matrix.

To further facilitate the training of the Markov matrices, it may be desirable to limit the number of trainable Markov transform parameters. Using the matrix form show in equation (11), the number of Markov transform parameters is C³. However, this number of trainable Markov transform parameters may not facilitate an efficient training process.

Optionally, each Markov matrix can be defined as a parameter constrained Markov matrix. A parameter constrained Markov matrix can be defined to include a maximum number of Markov transform parameters that is not greater than a predefined parameter threshold. This may help improve the efficiency of the training process where the Markov matrices are co-trained along with the weight parameters of the deep neural network model.

An example of a parameter constrained Markov matrix can be defined by limiting each class-specific trainable matrix [symbol] to the following form:

$$= α \times + {[ C , n ]}^{} {[ n , C ]}^{} \qquad ( 12 )$$

where [symbol] and [symbol] are two real-valued matrices, α is a trainable scaling factor, and n is referred to as the intrinsic dimension of [symbol] . In this case, the number of Markov transform parameters can be reduced to C(1+2nC), which can provide for more efficient training when the intrinsic dimension of the Markov matrix n is small.

Alternatively, the Markov transformed teacher label prediction outputs can be generated by applying a Markov transform directly to the teacher label prediction probability distributions output by the pre-trained teacher model. That is, the power transform may be omitted in some examples.

At 330, the student model error function can be evaluated using the Markov transformed teacher label prediction outputs from 325 and the student label prediction outputs output by the deep neural network model being trained. The student model error function can be implemented using various different loss functions used with distribution-based KD methods. However, the loss function is now applied to the Markov transformed teacher label prediction outputs generated at 325.

For example, the student loss function can be implemented in an identical manner to that of an underlying distribution-based KD method except that the student loss function now evaluates the Markov transformed teacher label prediction outputs \tilde{p}ₓ instead of the original teacher label prediction probability distributions pₓ output by the pre-trained teacher model. If temperature scaling is applied to pₓ in the underlying distribution-based KD method, then the student model error function can be evaluated using the power transformation as noted above at 325.

For example, if the underlying distribution-based KD method is a standard KD [6](in which case we refer to MKD specifically as MKD-KD), then the student loss function in MKD-KD can be defined as

$${𝔼}_{( X , Y )} [ H ( Y , {q}_{X , θ} ) + β {τ}^{2} D ( {\hat{\tilde{p}}}_{X} \vert \vert {\hat{q}}_{X , θ} ) ] \qquad ( 13 )$$

where τ is the temperature used in KD. In the above, when the power transform is applied to both \tilde{p}ₓ and q_{x,θ}, the power parameter can be defined as γ=1/τ.

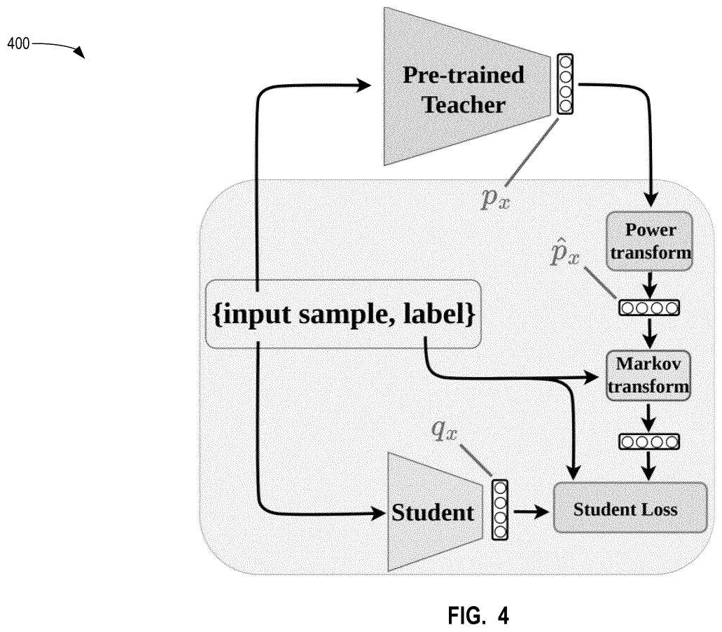

FIG. 4 illustrates an example process for evaluating the loss of a student model during the process of training the student model using a pre-trained teacher model. In the example shown in FIG. 4, the student loss function is evaluated using Markov transformed teacher label prediction outputs that are in turn generated based on a power transformation of the corresponding teacher label prediction output. The teacher label prediction output and student label prediction output are each generated in response to the same input sample. The student loss function is implemented in a manner identical to that of the underlying distribution-based KD method except that it now takes a Markov transformed label prediction output \tilde{p}ₓ instead of the label prediction output pₓ as one of its inputs.

At 335, the plurality of student model weight parameters θ can be updated. The student deep neural network can be configured to include a plurality of layers. The plurality of layers can include a plurality of intermediate layers arranged between an input layer and an output layer. A plurality of weight parameters can define the layer connections between each pair of adjacent layers in the plurality of layers. Optimizing the error function can include updating the plurality of weight parameters in response to inputting the plurality of training data samples into the input layer of the deep neural network. Various standard learning algorithms can be used to optimize the weight parameters, for instance using backward propagation and gradient descent algorithms.

Optionally, at 340 the Markov transform parameters of the Markov matrices (used at 325) can be trained concurrently with the student model weight parameters to optimize the error function of the deep neural network model. It will be appreciated that the Markov transform parameters and student model weight parameters may be trained in a parallel or alternating fashion in order to optimize the error function.

The student weight parameters and Markov transform parameters can be trained simultaneously to minimize the student loss. As an example, the student loss function in MKD can be defined as:

$${𝔼}_{( X , Y )} [ L ( Y , {q}_{X , θ} , {\tilde{p}}_{X} ) ]$$

The student weight parameters and Markov transform parameters can then be co-trained simultaneously by solving the co-training minimization problem:

$${min}_{θ} {min}_{, c ∈ [ C ]} {𝔼}_{( X , Y )} [ L ( Y , {q}_{X , θ} , {\tilde{p}}_{X} ) ] \qquad ( 14 )$$

The co-training minimization problem can also be represented as:

$${min}_{θ} {min}_{, c ∈ [ C ]} {𝔼}_{( X , Y )} [ H ( Y , {q}_{X , θ} ) + β {τ}^{2} D ( {\hat{\tilde{p}}}_{X} \vert \vert {\hat{q}}_{X , θ} ) ] \qquad ( 15 )$$

As will be appreciated, standard learning algorithms including backward propagation and stochastic gradient decent (SGD) can then be applied to solve (14).

The process 320 can repeat steps 325-340 (and also step 310 of method 300) iteratively in order to train the student deep neural network model. Once the training process is completed (e.g. after a desired number of training epochs have been completed), the weight parameters from 335 can be defined as trained weight parameters for the deep neural network model.

At 345, the trained weight parameters can be output (i.e. weight parameters θ^{T} can be output). The trained weight parameters can then be used in the student deep neural network model to provide the desired deep learning function. The trained weight parameters can be stored or otherwise output to a computing device 105 (or other device in communication with computing device 105).

The Markov transform parameters may not be output or stored persistently once the student model has been trained. The Markov transform parameters [symbol] , cϵ[C] themselves do not form part of the trained student model. Once the training process is done, the distilled student can be completely decoupled from the Markov transforms and can be used for inference applications as usual. Optionally, the Markov transform parameters can be discarded after the training process is complete.

Referring again to method 300, at 315 the trained deep neural network can be stored by storing the plurality of trained weight parameters from 310 (e.g. from step 345 of method 320) in one or more non-transitory data storage elements (e.g. database 115). The trained weight parameters can then be used by the deep neural network when classifying input samples. The Markov transform parameters need not be stored for the deep neural network once training is complete.

### EXPERIMENTAL RESULTS

The inventors conducted extensive experiments to evaluate the performance of the model training methods described herein. The distillation capability of the methods described herein was evaluated by applying the training methods to both nasty pre-trained teacher models and normal pre-trained teacher models.

The results, discussed below, show that the methods described herein enable deep neural networks to be trained based on nasty teacher models pre-trained by self-undermining KD. The inventors have also found that the methods described herein result in student models that outperform models trained using the underlying distribution-based KD methods, even where the training is performed with few shots. The inventors have further found that the methods described herein enable student models to be trained for cross-domain applications, i.e. enabling the transfer of knowledge from one training domain to another domain.

Experiments were conducted using datasets from three common image classification datasets: Cifar-10, Cifar-100, and TinylmageNet. For teacher-student pairs, teacher models were implemented using ResNet{18, 50}(shortened as R18 and R50, resp.) and ResNext29 (shortened as Rnt29), and student models were implemented using CNN, ResNetC{20, 32}(shortened as RC20 and RC32, resp.), MobileNetV2 (shortened as MV2), ShuffleNetV2 (shortened herein as SV2), and R18, where CNN denotes a customized 5-layer convolutional neural network.

For all experiments, a batch size of 128 was used for training across all models. Unless specified otherwise, the intrinsic dimension n of Markov transform was set to 3 for Cifar-10 and Cifar-100 and set to 5 for TinylmageNet. The SGD optimizer with a learning rate of 0.1 and momentum of 0.99 was used for ResNet, ShuffleNetV2, and MobileNetV2. For the CNN model, an Adam optimizer with a learning rate of 10⁻³ and momentum of 0.99 was used.

The inventors applied the MKD-KD training process (where standard KD was used as the underlying distribution-based KD method) to distill nasty teachers trained by self-undermining KD. Table 2 reports the resulting Top-1 validation accuracy results for student models trained using MKD-KD along with those delivered by CE student models, LS student models, KD trained models, and distribution-based KD methods designed specifically to distill nasty teachers, namely Skep., HTC and Avg. The results were obtained by averaging 3 independent runs. From Table 2, it is clear that although Skep., HTC, and Avg. can recover fully or partially the accuracy loss from the standard KD process, the distilled student models generated using these distribution-based KD methods still perform worse than the LS student model in general. On the other hand, the distilled student trained using MKD-KD consistently outperforms LS student. In particular, for the student model ShuffleNetV2, the accuracy gain over LS student is non-trivial and can be as high as 3.57%.

TABLE 2
Top-1 validation accuracy (%) of CE student, LS student, and various
distilled students from nasty teachers by different KD methods on
Cifar-{10, 100} and TinyImageNet datasets (averaged over 3 runs)

| | | | | | | | | |
|---|---|---|---|---|---|---|---|---|
| | | | | KD | Skep. | HTC | Avg. | |
| Tch. | Stu. | CE | LS | (NPIS 2015) | (NPIS 2021) | (ECCV 2022) | (ICLR 2023) | MKD-KD |

Cifar-10

| | | | | | | | | |
|---|---|---|---|---|---|---|---|---|
| R18 | CNN | 86.64 | 87.40 | 82.11 (↓) | 86.71 (↓) | 87.33 (↓) | 83.02 (↓) | 87.82 (↑) |
| | RC20 | 92.31 | 92.53 | 88.43 (↓) | 91.85 (↓) | 92.48 (↓) | 88.73 (↓) | 92.91 (↑) |
| | RC32 | 93.01 | 93.36 | 89.61 (↓) | 92.98 (↓) | 93.26 (↓) | 90.33 (↓) | 93.69 (↑) |

Cifar-100

| | | | | | | | | |
|---|---|---|---|---|---|---|---|---|
| R18 | MV2 | 69.00 | 70.37 | 6.53 (↓) | 66.47 (↓) | 69.64 (↓) | 71.45 (↑) | 71.41 (↑) |
| | SV2 | 71.52 | 71.56 | 64.43 (↓) | 70.46 (↓) | 71.62 (↑) | 71.26 (↓) | 72.39 (↑) |
| | R18 | 78.11 | 78.96 | 74.21 (↓) | 77.45 (↓) | 78.64 (↓) | 77.42 (↓) | 79.26 (↑) |
| R50 | MV2 | 69.00 | 70.37 | 4.23 (↓) | 66.94 (↓) | 69.73 (↓) | 67.42 (↓) | 71.68 (↑) |
| | SV2 | 71.52 | 71.56 | 64.69 (↓) | 71.44 (↓) | 71.58 (↑) | 70.59 (↓) | 72.33 (↑) |
| | R18 | 78.11 | 78.96 | 71.71 (↓) | 77.33 (↓) | 78.47 (↓) | 78.53 (↓) | 79.46 (↑) |
| Rnt29 | MV2 | 69.00 | 70.37 | 2.15 (↓) | 65.43 (↓) | 69.23 (↓) | 70.16 (↓) | 71.04 (↑) |
| | SV2 | 71.52 | 71.56 | 59.34 (↓) | 70.85 (↓) | 71.69 (↑) | 71.35 (↓) | 72.57 (↑) |
| | R18 | 78.11 | 78.96 | 66.42 (↓) | 75.48 (↓) | 78.29 (↓) | 78.93 (↓) | 79.27 (↑) |

TinyImageNet

| | | | | | | | | |
|---|---|---|---|---|---|---|---|---|
| R18 | MV2 | 54.62 | 55.79 | 1.04 (↓) | 54.87 (↓) | 55.42 (↓) | 55.63 (↓) | 55.74 (↑) |
| | SV2 | 56.76 | 57.91 | 25.42 (↓) | 58.24 (↑) | 56.78 (↓) | 57.42 (↓) | 60.21 (↑) |
| R50 | MV2 | 54.62 | 55.79 | 2.42 (↓) | 55.20 (↓) | 55.69 (↓) | 57.49 (↑) | 57.35 (↑) |
| | SV2 | 56.76 | 57.91 | 36.22 (↓) | 56.12 (↓) | 57.42 (↓) | 57.52 (↓) | 61.48 (↑) |

In Table 2 the (T) and (1) symbols respectively indicate better and worse performance as compared to the LS student. For each teacher-student pair, the best and the second best results are shown using bolding and u̅n̅d̅e̅r̅l̅i̅n̅i̅n̅g̅, respectively.

The inventors also applied the MKD methods described herein to normal teacher models to evaluate the performance of MKD as a generic distribution-based KID method. The standard KID and DKD were used as the respective underlying distribution-based KD methods in MKD and applied MKD-KD and MKD-DKD to the same teacher-students pairs as in Subsection 5.1 on Cifar-100 and TinylmageNet, except now all teachers are normal. Table 3 reports the resulting Top-1 validation accuracy results along with those delivered by KID and DKD themselves.

TABLE 3
Top-1 validation accuracy (%) of various distilled
students from normal teachers by KD, DKD, and
MKD on Cifar-100 and TinyImageNet datasets.

| | | | | | |
|---|---|---|---|---|---|
| Tch | Stu | KD | MKD-KD | DKD | MKD-DKD |

Cifar-100

| | | | | | |
|---|---|---|---|---|---|
| R18 | MV2 | 72.41 | 72.31 | 72.60 | 73.04 |
| | SV2 | 74.53 | 74.61 | 75.38 | 75.49 |
| | R18 | 79.35 | 79.45 | 79.62 | 79.74 |
| R50 | MV2 | 72.13 | 72.09 | 73.01 | 73.50 |
| | SV2 | 73.61 | 74.02 | 75.42 | 75.46 |
| | R18 | 79.46 | 79.92 | 80.09 | 80.23 |
| Rnt29 | MV2 | 72.43 | 72.65 | 72.68 | 72.97 |
| | SV2 | 72.68 | 73.23 | 75.04 | 75.35 |
| | R18 | 79.63 | 79.98 | 79.78 | 80.25 |

TinyImageNet

| | | | | | |
|---|---|---|---|---|---|
| R18 | MV2 | 55.99 | 56.33 | 59.22 | 59.43 |
| | SV2 | 58.09 | 60.96 | 61.60 | 62.09 |
| R50 | MV2 | 56.24 | 57.42 | 60.02 | 60.13 |
| | SV2 | 58.45 | 61.51 | 61.60 | 62.17 |

As can be seen from Table 3, MKD in general outperforms its underlying distribution-based KID method. In particular, for TinylmageNet dataset and the student model ShuffleNetV2, MKD outperforms KID by a large margin (as high as over 3%).

The inventors also evaluated the effectiveness of MKD in the case of few shot learning where only a small percentage of training samples are available in student learning. The accuracy of the student models trained using MKD was evaluated with MKD applied to distill knowledge from the both nasty teacher and normal teacher, when only a percentage of the training samples in each class are available. This was evaluated using R18 trained on Cifar-10 dataset by cross entropy and self-undermining knowledge distillation as the normal teacher and nasty teacher, respectively, and {CNN, RC20, RC32} as the student models. Experiments were conducted using different percents of the dataset, namely [10,30,50,70,90].

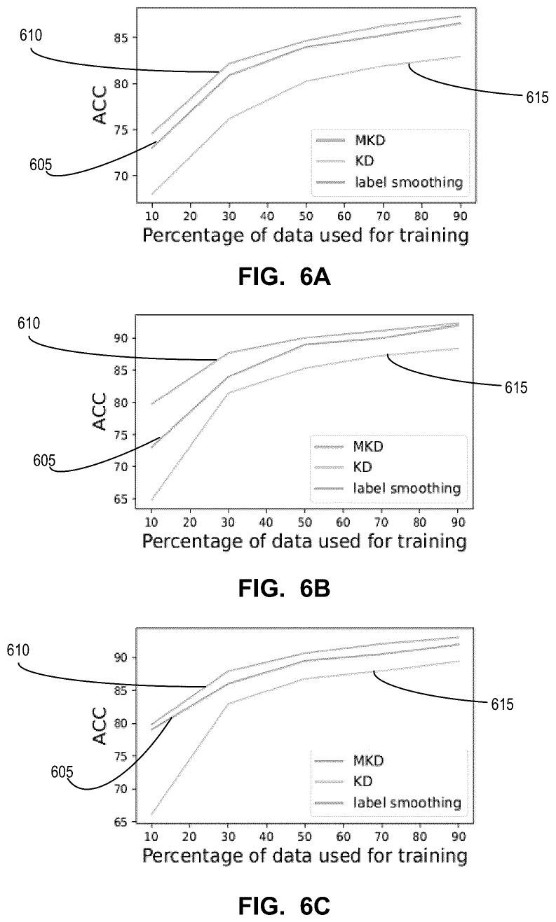

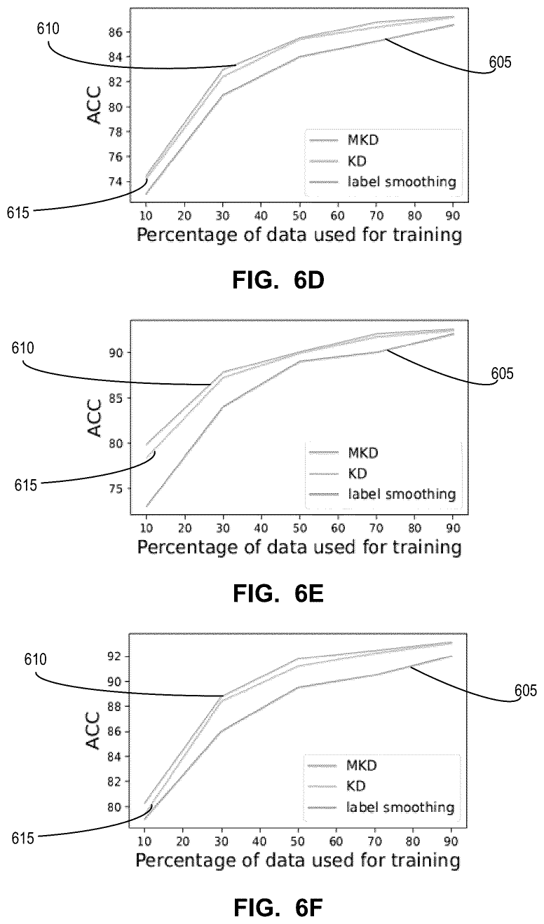

FIGS. 6A-6F show plots of the Top-1 validation accuracy (%) of distilled student models and an LS student model (see plot lines 605) trained using the different percents of the Cifar-10 dataset (averaged over 3 runs). FIGS. 6A-6C illustrate the results of training a student model based on the nasty teacher while FIGS. 6D-6F illustrate the results of training a student model based on the normal teacher.

As can be seen from FIGS. 6A-6C, MKD-KD (see plot lines 610) consistently distills the nasty teacher even with only subset of the training data available, whereas the nasty teacher is shown again to be KD-resistant with respect to KD (see plot lines 615) in the few-shot settings. Further, FIGS. 6D-6F illustrate that when MKD-KD and KD are applied to the normal teacher, distilled students trained using MKD-KD always outperform distilled students trained using standard KD for all tested few-shot settings.

The inventors also evaluated the ability of MKD to transfer knowledge from teachers trained in one domain to students trained in another domain. As the results show, MKD is able to transfer knowledge from one domain to another domain. Specifically, it is shown that a teacher trained in one domain (say a set of images with a label set) is fully distillable by MKD to a student trained in another domain (say a different set of images with a different non-overlapping label set), regardless of whether the teacher is normal or nasty.

The inventors evaluated the accuracy of the MKD methods described herein using a pre-trained teacher that was trained on one domain to train a student model on another domain where the two domains do not overlap. Two cross-domain datasets dubbed Cifar-50-50 and TinylmageNet-100-100 were defined for this purpose.

The Cifar-50-50 dataset was defined by randomly partitioning the label set of Cifar-100 into two equal-sized subsets, each containing 50 labels. All samples in the Cifar-100 dataset with labels from the first subset were grouped into the Cifar-50-50 Domain-1 dataset which contained 25K training samples and 5K validation samples. Likewise, all samples in the Cifar-100 dataset with labels from the second subset were grouped into the Cifar-50-50 Domain-2 dataset which also contained 25K training samples and 5K validation samples.

The TinylmageNet-100-100 was similarly created by randomly partitioning the label set of TinylmageNet into two equal-sized subsets, each containing 100 labels, creating the resultant TinylmageNet-100-100 Domain-1 dataset and TinylmageNet-100-100 Domain-2 dataset.

The Domain-1 and Domain-2 datasets defined above do not share any single common label. The inventors trained the teacher models (nasty and normal) using the Domain-1 dataset. Both KD and MKD-KD were applied to distill those teachers and train student models using the Domain-2 dataset. That is, the input samples used to train the student models based on the pre-trained teacher models all came from the Domain-2 dataset. In MKD, the scaling factor α was set to 0, and the intrinsic dimension n was set to 16 for Cifar-50-50 and 25 for TinylmageNet-100-100.

Table 4 reports the resulting Top-1 validation accuracy results of distilled students by KD and MKD-KD, CE student, and LS student on Cifar-50-50. Note that the distilled student trained by KD is completely confused due to cross-domain transfer. On the other hand, the distilled student trained by MKD-KD always outperforms LS student, even though the teacher was trained in a completely different domain. The cross-domain distillation capability of MKD is due to the use of Markov transforms. The co-learning of Markov transform parameters also supports cross-domain distillation.

TABLE 4
Top-1 validation accuracy (%) of various
students in cross-domain distillation

| | | | |
|---|---|---|---|
| KD | MKD-KD | KD | MKD-KD |

Cifar-50-50

| Stu. | CE | LS | Nasty R18 | | Normal R18 | |
|---|---|---|---|---|---|---|
| MV2 | 78.95 | 78.98 | 4.04 | 80.02 | 8.18 | 79.53 |
| SV2 | 79.04 | 79.18 | 8.87 | 80.21 | 4.10 | 79.91 |
| Stu. | CE | LS | Nasty R50 | | Normal R50 | |
| MV2 | 78.95 | 78.98 | 9.30 | 79.12 | 3.12 | 79.32 |
| SV2 | 79.04 | 79.18 | 8.23 | 79.84 | 6.24 | 79.94 |
| Stu. | CE | LS | Nasty Rnxt29 | | Normal Rnxt29 | |
| MV2 | 78.95 | 78.98 | 7.36 | 79.16 | 3.27 | 79.53 |
| SV2 | 79.04 | 79.18 | 8.38 | 80.17 | 4.75 | 79.84 |

TinyImageNet-100-100

| Stu. | CE | LS | Nasty R18 | | Normal R18 | |
|---|---|---|---|---|---|---|
| MV2 | 63.22 | 63.95 | 5.36 | 65.14 | 8.39 | 66.15 |
| SV2 | 65.14 | 65.40 | 7.36 | 67.25 | 3.93 | 67.09 |
| Stu. | CE | LS | Nasty R50 | | Normal R50 | |
| MV2 | 63.22 | 63.95 | 6.74 | 66.04 | 10.28 | 66.80 |
| SV2 | 65.14 | 65.40 | 8.20 | 66.54 | 6.25 | 66.56 |

As can be seen from Table 4, the distilled student models trained using KD are completely confused, whereas the distilled student models trained using MKD-KD consistently outperform the LS student models. Notably, for the distilled student model MobileNetV2 trained using MKD-KD, the accuracy gain over the LS student can be as high as 2.85%.

While the above description provides examples of one or more methods or apparatuses or systems, it will be appreciated that other methods or apparatuses or systems may be within the scope of the accompanying claims.

It will be appreciated that the embodiments described in this disclosure may be implemented in a number of computing devices, including, without limitation, servers, suitably-programmed general purpose computers, cameras, sensors, audio/video encoding and playback devices, set-top television boxes, television broadcast equipment, mobile devices, and autonomous vehicles. The embodiments described in this disclosure may be implemented by way of hardware or software containing instructions for configuring a processor or processors to carry out the functions described herein. The software instructions may be stored on any suitable non-transitory computer readable memory, including CDs, RAM, ROM, Flash memory, etc.

It will be understood that the embodiments described in this disclosure and the module, routine, process, thread, or other software component implementing the described methods/processes/frameworks may be realized using standard computer programming techniques and languages. The present application is not limited to particular processors, computer languages, computer programming conventions, data structures, other such implementation details. Those skilled in the art will recognize that the described methods/processes may be implemented as a part of computer-executable code stored in volatile or non-volatile memory, as part of an application-specific integrated chip (ASIC), etc.

As will be apparent to a person of skill in the art, certain adaptations and modifications of the described methods/processes/frameworks can be made, and the above discussed embodiments should be considered to be illustrative and not restrictive.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

We claim:

1. A method of training a deep neural network model using a pre-trained teacher model, wherein the pre-trained teacher model is configured to output a teacher label prediction in response to receiving a teacher input value and the deep neural network is configured to output a student label prediction in response to receiving a student input value, the method comprising:
inputting a plurality of student training data samples into the deep neural network model and a plurality of teacher training data samples into the pre-trained teacher model, wherein each training data sample comprises a training input value, each training input value has an associated true label, and each true label corresponds to a particular class from amongst a plurality of potential classes; and
generating a trained deep neural network model using the plurality of training data samples to optimize an error function of the deep neural network model, wherein the error function is evaluated using a plurality of student label prediction outputs and a plurality of Markov transformed teacher label prediction outputs, wherein each student label prediction output is generated by the deep neural network model in response to receiving one of the student training data samples as an input, wherein each Markov transformed teacher label prediction output is generated based on a teacher label prediction output by the pre-trained teacher model in response to receiving one of the teacher training data samples as an input, and wherein each Markov transformed teacher label prediction output is generated through a Markov transform involving matrix multiplication using a Markov matrix.

2. The method of claim 1, wherein each Markov transformed teacher label prediction output is generated based on a power transformation of the corresponding teacher label prediction output.

3. The method of claim 2, wherein each teacher label prediction output comprises a teacher label prediction probability distribution.

4. The method of claim 3, further comprising generating the plurality of Markov transformed teacher label prediction outputs by:
generating a plurality of power transformed probability distributions by applying a power transform to each of the teacher label prediction probability distributions output by the pre-trained teacher model in response to receiving the plurality of teacher training data samples; and
generating the plurality of Markov transformed teacher label prediction outputs from the plurality of power transformed probability distributions by applying Markov transforms to each power transformed probability distribution.

5. The method of claim 1, wherein the plurality of Markov transformed teacher label prediction outputs are generated using a plurality of class-specific Markov matrices, wherein each potential class in the plurality of potential classes has a corresponding class-specific Markov matrix.

6. The method of claim 5, wherein each Markov matrix is defined as a parameter constrained Markov matrix that includes a maximum number of Markov transform parameters that is not greater than a predefined parameter threshold.

7. The method of claim 1, wherein:
the plurality of student training data samples and the plurality of teacher training data samples are non-overlapping sets.

8. The method of claim 1, wherein:
the teacher model is pre-trained using a plurality of teacher pre-training data samples; and
the plurality of student training data samples and the plurality of teacher pre-training data samples are non-overlapping sets.

9. The method of claim 1, wherein the deep neural network comprises a plurality of layers, the plurality of layers including a plurality of intermediate layers arranged between an input layer and an output layer, the deep neural network comprises a plurality of weight parameters defining layer connections between each pair of adjacent layers in the plurality of layers, and optimizing the error function comprises updating the plurality of weight parameters in response to inputting the plurality of training data samples into the input layer of the deep neural network.

10. The method of claim 9, further comprising concurrently training Markov transform parameters of the Markov matrices to optimize the error function of the deep neural network model.

11. A computer program product for training a deep neural network model using a pre-trained teacher model, wherein the pre-trained teacher model is configured to output a teacher label prediction in response to receiving a teacher input value and the deep neural network is configured to output a student label prediction in response to receiving a student input value, the computer program product comprising a non-transitory computer readable medium having computer executable instructions stored thereon, the instructions for configuring one or more processors to perform a method of training the deep neural network, wherein the method comprises:
inputting a plurality of student training data samples into the deep neural network model and a plurality of teacher training data samples into the pre-trained teacher model, wherein each training data sample comprises a training input value, each training input value has an associated true label, and each true label corresponds to a particular class from amongst a plurality of potential classes; and
generating a trained deep neural network model using the plurality of training data samples to optimize an error function of the deep neural network model, wherein the error function is evaluated using a plurality of student label prediction outputs and a plurality of Markov transformed teacher label prediction outputs, wherein each student label prediction output is generated by the deep neural network model in response to receiving one of the student training data samples as an input, wherein each Markov transformed teacher label prediction output is generated based on a teacher label prediction output by the pre-trained teacher model in response to receiving one of the teacher training data samples as an input, and wherein each Markov transformed teacher label prediction output is generated through a Markov transform involving matrix multiplication using a Markov matrix.

12. The computer program product of claim 11, wherein each Markov transformed teacher label prediction output is generated based on a power transformation of the corresponding teacher label prediction output.

13. The computer program product of claim 12, wherein each teacher label prediction output comprises a teacher label prediction probability distribution.

14. The computer program product of claim 13, wherein the method further comprises generating the plurality of Markov transformed teacher label prediction outputs by:
generating a plurality of power transformed probability distributions by applying a power transform to each of the teacher label prediction probability distributions output by the pre-trained teacher model in response to receiving the plurality of teacher training data samples; and
generating the plurality of Markov transformed teacher label prediction outputs from the plurality of power transformed probability distributions by applying Markov transforms to each power transformed probability distribution.

15. The computer program product of claim 11, wherein the plurality of Markov transformed teacher label prediction outputs are generated using a plurality of class-specific Markov matrices, wherein each potential class in the plurality of potential classes has a corresponding class-specific Markov matrix.

16. The computer program product of claim 15, wherein each Markov matrix is defined as a parameter constrained Markov matrix that includes a maximum number of Markov transform parameters that is not greater than a predefined parameter threshold.

17. The computer program product of claim 11, wherein the plurality of student training data samples and the plurality of teacher training data samples are non-overlapping sets.

18. The computer program product of claim 11, wherein:
the teacher model is pre-trained using a plurality of teacher pre-training data samples; and
the plurality of student training data samples and the plurality of teacher pre-training data samples are non-overlapping sets.

19. The computer program product of claim 11, wherein the deep neural network comprises a plurality of layers, the plurality of layers including a plurality of intermediate layers arranged between an input layer and an output layer, the deep neural network comprises a plurality of weight parameters defining layer connections between each pair of adjacent layers in the plurality of layers, and optimizing the error function comprises updating the plurality of weight parameters in response to inputting the plurality of training data samples into the input layer of the deep neural network.

20. The computer program product of claim 19, wherein the method further comprises concurrently training Markov transform parameters of the Markov matrices to optimize the error function of the deep neural network model.

21. A system for training a deep neural network model using a pre-trained teacher model, wherein the pre-trained teacher model is configured to output a teacher label prediction in response to receiving a teacher input value and the deep neural network is configured to output a student label prediction in response to receiving a student input value, the system comprising:
one or more processors; and
one or more non-transitory storage mediums;
wherein
the one or more processors are configured to:
input a plurality of student training data samples into the deep neural network model, wherein each training data sample comprises a training input value, each training input value has an associated true label, and each true label corresponds to a particular class from amongst a plurality of potential classes; and
generate a trained deep neural network model using the plurality of training data samples to optimize an error function of the deep neural network model, wherein the error function is evaluated using a plurality of student label prediction outputs and a plurality of Markov transformed teacher label prediction outputs, wherein each student label prediction output is generated by the deep neural network model in response to receiving one of the student training data samples as an input, wherein each Markov transformed teacher label prediction output is generated based on a teacher label prediction output by the pre-trained teacher model in response to receiving a teacher training data sample from amongst a plurality of teacher training data samples as an input, and wherein each Markov transformed teacher label prediction output is generated through a Markov transform involving matrix multiplication using a Markov matrix.
